(19) United States
(12) Patent Application Publication
(10) Pub. No.: US 2006/0288061 A1
(43) Pub. Date: Dec. 21, 2006

(54) Smaller and faster comparators

(75) Inventors: Dominic Nancekievill, West Wycombe (GB); Paul Metzgen, Chiswick London (GB)

Correspondence Address: FISH & NEAVE IP GROUP, ROPES & GRAY LLP, 1251 AVENUE OF THE AMERICAS FL C3, NEW YORK, NY, 10020-1105, US

(73) Assignee: Altera Corporation, San Jose, CA (US)

(21) Appl. No.: 11/157,343

(22) Filed: Jun. 20, 2005

(51) Int. Cl. G06F 15/00

(52) U.S. Cl. 708/200

(57) ABSTRACT

Adder units are used to compare two numbers. A first logic unit receives one or more bits from a first number and the bits from a second number less the least significant bit of that second number. A second logic unit receives one or more bits from the second number and the bits from the first number less the least significant bit of that first number. The logic units generate, based on the logic values (bits) input into the logic units, logic values and output those values to an adder unit. Using these values, in addition to a “Carry In” value, the adder unit generates an output. The output is at least partially determinative of whether the second number is greater than the first number. Comparators designed in accordance with the present invention incur less delay (i.e., are faster) and require less inputs into logic look-up tables than prior comparators.

### BACKGROUND

Comparing two numbers forms one of the fundamental building blocks of logical operations. The use of logic operations in circuits, microprocessors, and computer systems is widespread. Increasing the speed at which compare operations take place as well as reducing the amount of components to compare two numbers is therefore desirable.

### SUMMARY

The present invention uses adder units to compare two numbers. Numbers can be represented using bits. Logic values (a 0 or 1; bits) from a first number and logic values from a second number are fed to logic units. The logic units perform logic operations on the logic values (bits) and output the result of the logic operations to an adder unit.

The adder unit performs an operation on these values and a “carry in” value (e.g., from a previous adder unit in a chain of adder units), and feeds the result to an output. The output of an individual adder unit is partially determinative of whether the second number is greater than the first. If an adder unit is the last in a chain of adder units, the output of that adder unit is determinative of which number is greater.

Known comparators require a look-up table (e.g., a logic unit) with the same amount of inputs as the number of bits being compared. For example, if two two-bit numbers are being compared, a look-up table would require four inputs. Additionally, the known comparators would also require that all of the bits of both numbers be input into the look-up table.

Comparators of the present invention use logic units that perform logic operations that do not require that all of the bits of both sets of numbers be fed into the logic units. Therefore, less inputs are required. Additionally, smaller look-up tables (i.e., those that have fewer inputs) can be utilized to perform compare operations. For example, to compare two pairs of two-bit numbers, two logic units (look-up tables) with three inputs each can compare the numbers.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1A is a conventional representation of a known comparator for comparing two N-bit numbers;

FIG. 1B is a table showing different logic outputs of the known comparator of FIG. 1A for different values of the two N-bit numbers;

FIG. 2 is a known chain of logic elements for comparing two three-bit numbers;

FIG. 3A is a conventional adder unit for adding two bits;

FIG. 3B is a logic table showing the output of the adder unit of FIG. 3A as a function of inputs;

FIG. 4A is a logic unit that performs logic operations on two bits and sends the outputs of the logic operations to an adder unit;

FIG. 4B is the logic and corresponding outputs that the logic unit of FIG. 4A performs on two bits;

FIG. 5A is a logic unit that performs logic operations on two bits and sends the outputs of the logic operations to an adder unit;

FIG. 5B is the logic and corresponding outputs that the logic unit of FIG. 5A performs on two bits;

FIG. 6 is a comparison of the outputs of the logic units of FIGS. 4A and 5A;

FIG. 7A is a logic unit that performs logic operations on two bits and sends the outputs of the logic operations to an adder unit;

FIG. 7B is two logic units that individually perform logic operations on an individual bit and sends the output of the logic operations to an adder unit;

FIG. 8A is two logic units that individually perform logic operations on bits and sends the output of the logic operations to an adder unit;

FIGS. 8B, 8C, and 8D are the logic and corresponding outputs that the logic units of FIG. 8A perform on the bits;

FIG. 9 is two logic units implemented as look-up tables that perform logic operations on bits and sends the output of the logic operations to an adder unit;

FIG. 10 is two adder units implemented on a Stratix II Adaptive Logic Module made by Altera Corporation of San Jose, Calif. with corresponding logic for comparing two sets of two-bit pairs of numbers; and

FIGS. 11 and 12 are two five- and seven-input look-up tables, respectively, that perform logic operations on bits and sends the output of the logic operations to an adder unit.

### DETAILED DESCRIPTION

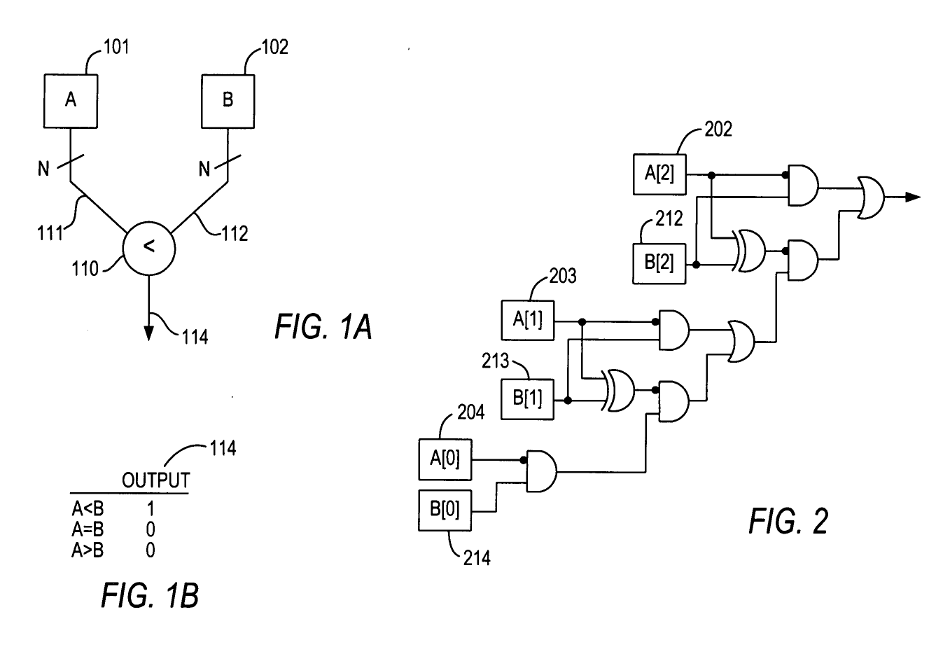

FIG. 1A shows a conventional representation of known comparators. Two numbers, number A 101 and number B 102, are compared by comparator 110. Numbers A and B are fed into comparator 110 via input paths 111 and 112, respectively. The hash marks on paths 111 and 112 indicate that numbers A and B may be of any length. That is, numbers A and B may be “N” bits long. When comparing two numbers, the two numbers are preferably the same amount of bits long. Comparator 110 outputs the result of the compare operation via output 114.

Possible results of the compare operation are represented in FIG. 1B. As shown, if number A is less than number B, the result at output 114 is a logic 1. If, number A is equal to or greater than number B, the result is a logic 0.

FIG. 2 shows how standard logic components are arranged to perform a logic operation using known comparator techniques. In FIG. 2, two three-bit numbers are compared. The individual bits of a number A—bit A[2] 202, bit A[1] 203, bit A[0] 204—and the individual bits of a number B—bit B[2] 212, bit B[1] 213, bit B[0] 214—are compared. As illustrated, logic elements (i.e., AND, OR, EX-OR) for comparing the bits of numbers A and B in bit position 0, bit position 1, and bit position 2 are combined into groups of logic primitives. These logic primitives are “packed” into look up tables on, for example, a microprocessor for compare operations.

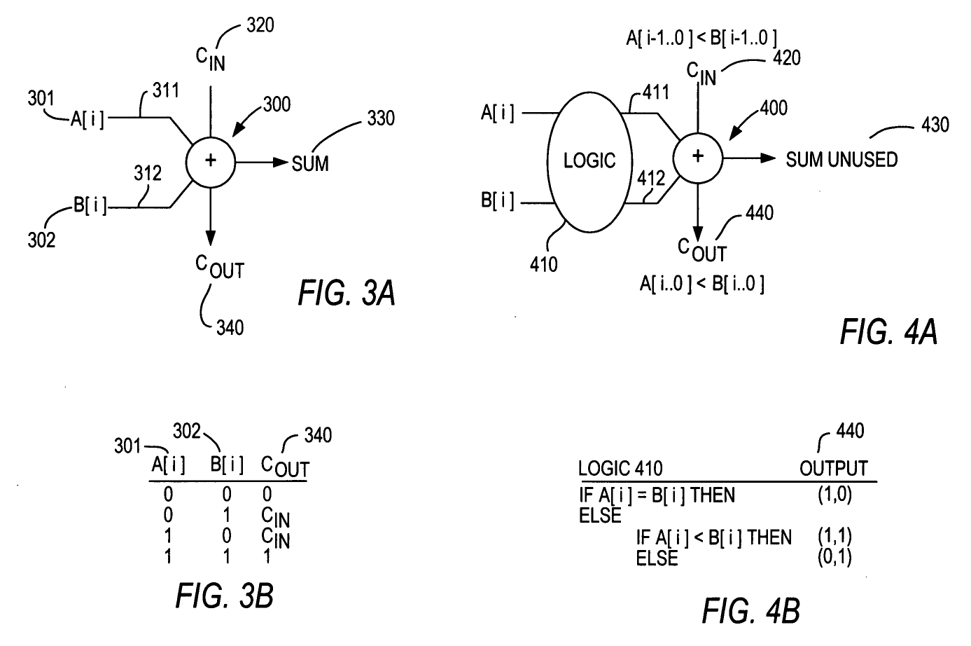

Turning to FIG. 3A, an adder unit for adding two bits is illustrated. Single adder unit 300 adds a single bit from each of number A 301 and number B 302 (represented as “A[i]” and “B[i],” respectively). The two bits are preferably from the same bit position of each number. Single bits from number A and number B are input into adder unit 300 via input paths 311 and 312, respectively. Adder unit 300 may be a single unit that is part of a chain of adder units. In addition to adding the two bits, adder unit 300 also takes into account “C_{IN}” 320 from a previous add operation (from, e.g., another adder unit in a chain of adder units). C_{IN}, or “Carry In,” is a single bit with a logic value of 0 or 1. If, for example, the previous adder unit in the chain of adder units had at both of its inputs from number A and number B a logic value of 1, the two logic values were added and generated a carry (i.e., 1 plus 1 in binary is 0 with a carry of 1 to the next most significant bit position).

In addition to the three inputs (i.e., C_{IN}, input from number A, and input from number B), adder unit 300 has two outputs: “Sum” 330 and “C_{OUT}=” 340. The “Sum” of adder unit 300 is represented logically as: A XOR B XOR C_{IN}. In the preferred embodiment of the present invention, the Sum can be disregarded. As such, further discussion on the Sum is not warranted. C_{OUT}, or “Carry Out,” is a single bit with a logic value of 0 or 1. If there is an additional adder unit in a chain of adder units, C_{OUT} may be C_{IN} of the next adder unit in the chain.

FIG. 3B is a logic table illustrating the logic values that adder unit 300 outputs as a function of single bit inputs. As shown, if A[i] is equal to B[i], then C_{OUT} is equal to A[i] and B[i] regardless of C_{IN}. However, if A[i] is not equal to B[i], then C_{OUT} is C_{IN}.

For ease of description, a nomenclature is used to describe the input into adder units. The nomenclature is a “left-side” logic value and a “right-side” logic value surrounded by parentheses and separated by a comma (e.g., the values of A[i] and B[i] in the third line of logic values in FIG. 3B may be represented as “(1,0)”). The “left-side” logic value is the logic value that an adder unit interprets as a logic value from a particular bit position of number A. The “right-side” logic value is the logic value that the adder unit interprets as a logic value from the same bit position of number B.

Assuming that the logic value of a particular bit position of a number is passed directly through to the adder unit (e.g., no logic intervenes), the logic value the adder unit interprets to be from that bit position will be the logic value of that bit position as presented to the adder unit. On the other hand, if a logic unit (e.g., logic unit 410, logic unit 510, logic unit 710, logic unit 760, logic unit 770, logic unit 860, logic unit 870; described in detail in connection with FIGS. 4-8) is placed before an input of the adder unit, the adder unit will interpret the output of the logic unit as its input.

Turning to FIGS. 4A and 4B, an adder unit with logic is shown. Adder unit 400 is an adder unit similar to adder unit 300. Adder unit 400 receives as an input a C_{IN} 420 from another adder unit (if any) in a chain. Adder unit 400 also outputs a sum 430 (which can be disregarded) and a C_{OUT} 440. The inputs to adder unit 400 from bit position i of number A and bit position i of number B are preferably not passed directly through to the adder as is the case with adder unit 300. Logic unit 410 intervenes on input paths 411 and 412 and performs one or more logic operations on the bits from numbers A and B. Adder unit 400 interprets the two outputs (two logic values) of logic unit 410 as bits from numbers A and B. Adder unit 400 then performs a logic operation on those two logic values in a similar fashion to adder unit 300.

FIG. 4B illustrates the logic operations and outputs that logic unit 410 performs. The logic operations are two “if . . . else . . . ” statements, one nested inside the other. If the i'th bit of A (“A[i]”) is equal to the i'th bit of B (“B[i]”), then logic unit 410 outputs (1,0). (“(1,0)” using the nomenclature described above indicates here that adder unit 400 interprets the input from bit position i of number A as a logic 1 and interprets the input from bit position i of number B as a logic 0.) If A[i] does not equal B[i], then logic unit 410 determines whether A[i] is less than B[i]. If yes, the output is (1,1). If no, then logically A[i] is greater than B[i]. The output in this circumstance is (0,0).

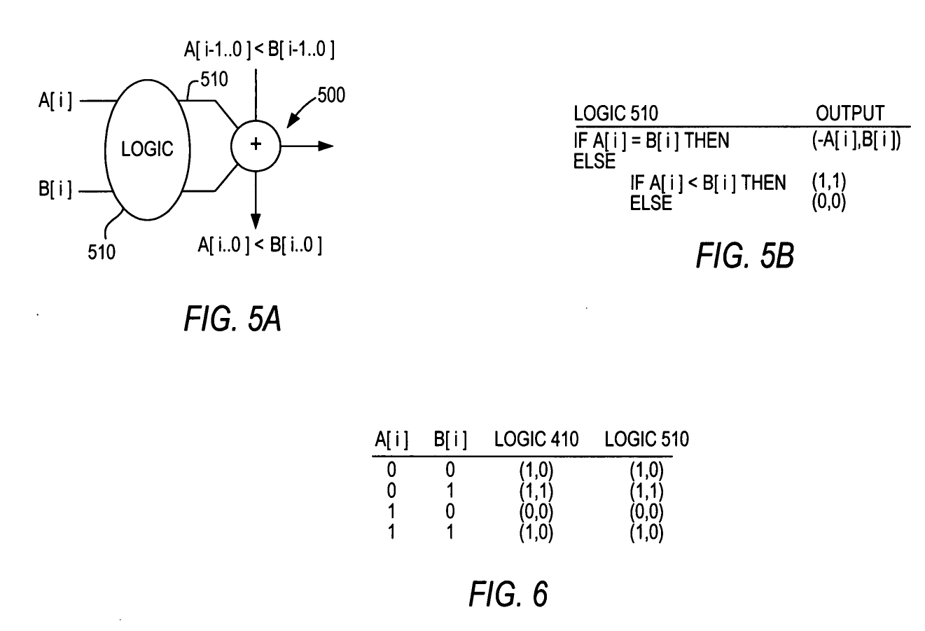

FIG. 5A shows another adder unit 500 with logic unit 510. As shown, logic unit 510 receives an i'th bit of number A and the i'th bit of number B. The logic operations that logic unit 510 performs and its outputs are shown in FIG. 5B. The first logic operation performed by logic unit 510 is determining if A[i] is equal to B[i]. If A[i] is equal to B[i] is equal to 0, the output is (1,0). If A[i] is equal to B[i] is equal to 1, the output is (0,1). This logic operation can be represented logically as “If A[i]=B[i], then (−A[i],B[i]).” This logic operation will be referred to herein as a “negative A” logic operation or a “NOT A” logic operation. If A[i] is not equal to B[i], then logic unit 510 determines whether A[i] is less than B[i]. If A[i] is less than B[i], then the output is (1,1). If not, then the output is (0,0).

In its most simple logical representation, the logic operations that logic unit 510 performs can be reduced to one statement: (−A[i],B[i]). This is because if A[i] is equal to B[i] is equal to 0, the output is (1,0) (i.e., (−0,0)). If A[i] is equal to B[i] is equal to 1, the output is (0,1) (i.e., (−1,1)). If A[i] is less than B[i] (which can only logically happen when A[i] is 0 and B[i] is 1), then the output is (1,1) (i.e., (−0,1)). If A[i] is greater than B[i] (which can only logically happen when A[i] is 1 and B[i] is 0), then the output is (0,0) (i.e., (−1,0)).

Note that logic units 410 and 510 generate the same outputs when A[i] is equal to B[i] is equal to 0; A[i] is less than B[i]; and A[i] is greater than B[i]. However, when A[i] is equal to B[i] is equal to 1, logic units 410 and 510 generate different outputs. As shown above in FIG. 3B, outputs of (1,0) and (0,1) have the same effect on the operation of adder units (i.e., C_{OUT} will be C_{IN}). Inputs into logic units 410 and 510 and respective outputs are compared in FIG. 6.

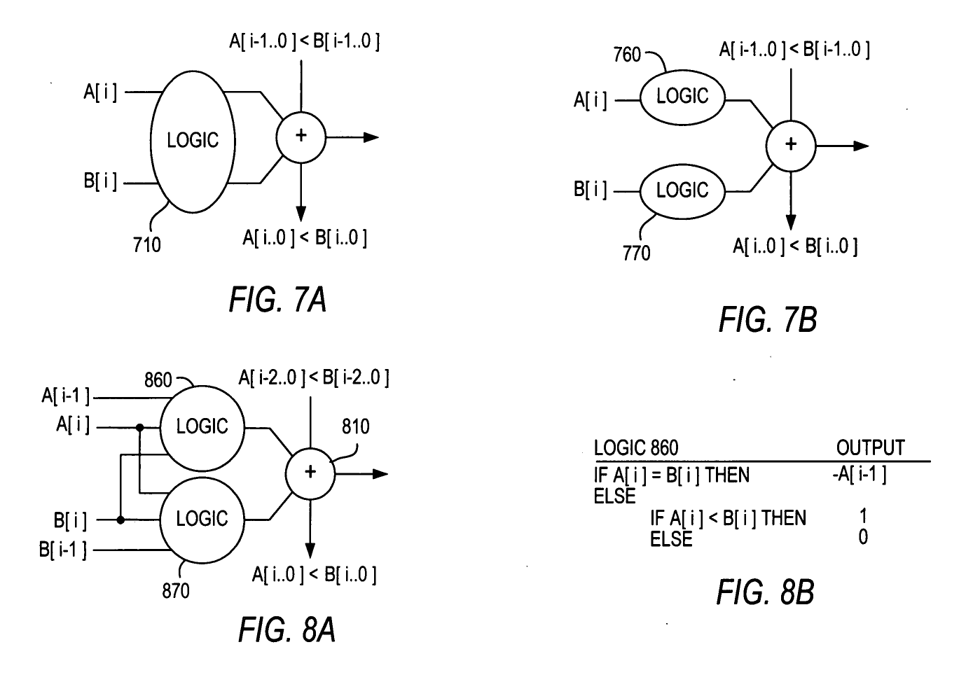

Using the logic operations as performed by logic unit 510, the same results of those logic operations can be achieved without feeding both A[i] and B[i] to the same logic unit (as is required using logic unit 410). In other words, logic unit 510 can be separated into two logic units; one for receiving A[i] and the other for receiving B[i]. This principle is shown in FIGS. 7A and 7B. FIG. 7A shows a logic unit 710 which can be separated into logic units 760 and 770 (FIG. 7B) for individually receiving inputs A[i] and B[i], respectively.

In application, this means that two single-input look-up tables can be used to compare two bits. Each single-input look up table receives a single bit and outputs a single bit accordingly. The two single-input look-up tables can be used instead of an individual two-input look-up table (as used in logic unit 410).

Extrapolating this difference, it is also possible to use two three-input look-up tables to compare four bits as two pairs of two bits each. A pair of bits from a number A and a pair of bits from a number B are compared to determine which pair is greater. Each bit in the pair of bits are preferably in neighboring bit positions. In other words, the bits in the pair are preferably next to each other in the number (e.g., bit position i−3 and bit position i−4 where “i−3” is the fourth MSB and “i−4” is the fifth MSB (the bit positions three and four bit positions away from the MSB)). Additionally, the bit positions in number A are preferably identical to the bit positions of number B.

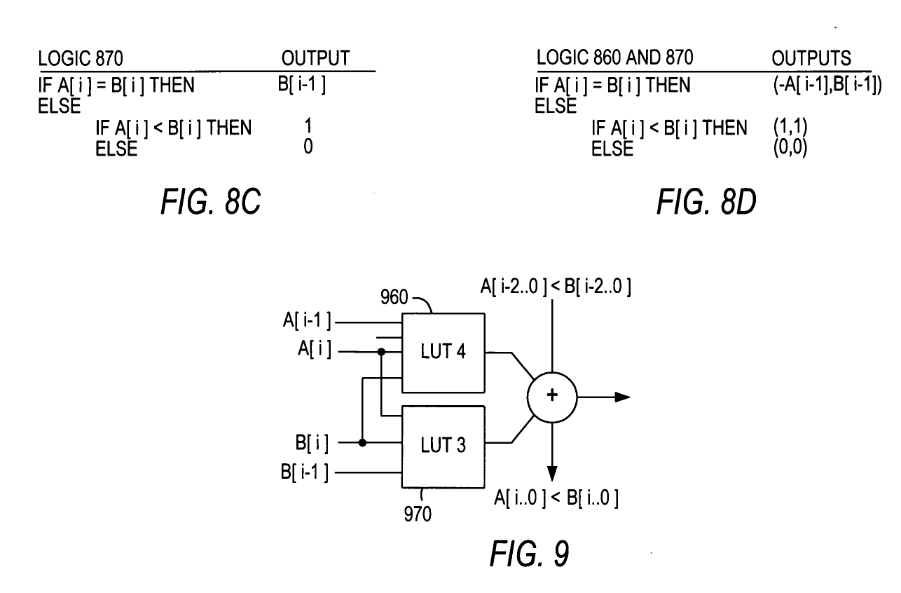

Two logic units 860 and 870 for performing logic operations on a pair of bits from a number A and a corresponding pair (same bit positions) of bits from number B is shown in FIG. 8A. The logic operations and outputs of logic units 860 and 870 are shown in FIGS. 8B and 8C, respectively. The logic operations and outputs of logic units 860 and 870 are shown combined in FIG. 8D.

The first step in determining which pair of bits is greater is comparing the MSBs of both pairs. The MSBs have to be directly compared against each other. Thus, logic units such as units 860 and 870 for comparing pairs of bits have the MSB of both pairs as an input.

If the MSBs of the pair of numbers are equal, then the LSBs (out of the pair of two numbers) determine whether the pair of bits from number A is greater than, less than, or equal to the pair of bits from number B. Instead of inputting the LSBs of both pairs of numbers in logic units (e.g., units 860 and 870) and thereby using more inputs into look-up tables (logic units) than necessary, the negative A logic operation described in connection with FIGS. 5A, 5B, 6, and 7B can be used. If a standard compare operation (e.g., logic unit 410) is used to compare the LSBs, this would require that the LSBs of both pairs be input into both logic units. Instead of using a standard compare operation, a negative A logic operation can be performed on the LSBs.

This can be expressed logically as “If A[i]=B[i], then (−A[i−1], B[i−1]).” Performing a negative A logic operation on the LSBs logically achieves a correct result without directly comparing (inputting both numbers into the same logic unit) the two numbers against each other.

Because the LSBs of the pairs need not be directly compared against each other, logic units 860 and 870 need not have both LSBs as their inputs. As mentioned above however, the MSBs of both pairs are input into logic units 860 and 870. As shown in FIG. 8A, logic unit 860—which sends its output to adder unit 810 as a “left-side” input—and logic unit 870—which sends its output to adder unit 810 as a “right-side” input—both receive the MSBs of each pair of numbers (i.e., they both receive “A[i]” and “B[i]”). However, as also shown in FIG. 8A, the LSB of number A (i.e., “A[i−1]”) is input into logic unit 860 only. Similarly, the LSB of number B (i.e., “B[i−1]”) is input into logic unit 870 only.

If the MSB of the pair of numbers from number A is less than the MSB of the pair of numbers from number B, logic unit 860 outputs a logic 1 and logic unit 870 also outputs a logic 1 (i.e., an output of (1,1)). If the MSB of the pair of numbers from number A is greater than the MSB of the pair of numbers from number B, logic unit 860 outputs a logic 0 and logic unit 870 also outputs a logic 0 (i.e., an output of (0,0)).

Logic units such as units 860 and 870 are implemented as look-up tables. As shown in FIG. 9, units 860 and 870 may be look-up tables that have at least three-inputs. For example, look-up table 960 has four inputs and look-up table 970 has three inputs. As also shown in FIG. 9, table 960 has as its inputs both bits from a pair of bits from a number A (represented as A[i] and A[i−1]) and the MSB of the pair of bits from number B. These are three inputs. Table 960 is a four-input look-up table and as such does not use one of its inputs. Table 970 has as its inputs both bits from a pair of bits from a number B (represented as B[i] and B[i−1] and the MSB of the pair of bits from number A. All three inputs of look-up table 970 are used.

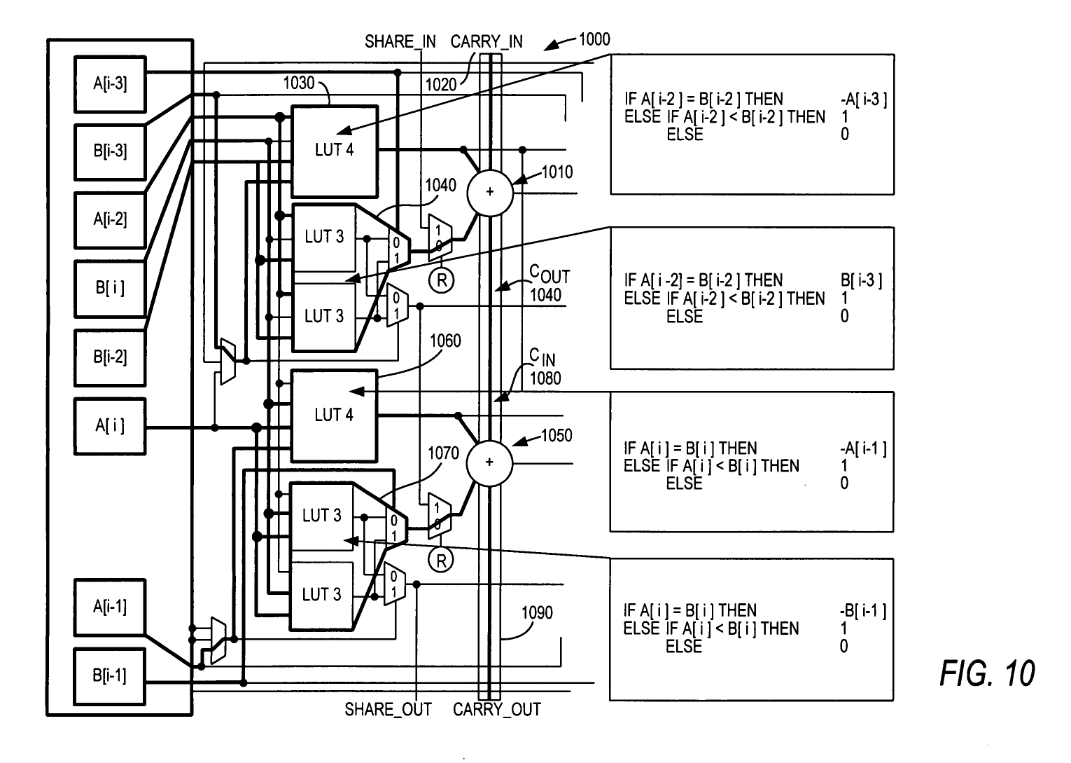

Logic modules which include adder units can be adapted for use as a comparator. For example, the Stratix II Adaptive Logic Module made by the Altera Corporation of San Jose, Calif. can be adapted for use in compare operations. FIG. 10 shows a portion of a Stratix II Adaptive Logic Module (“ALM”) 1000 configured to implement a comparison of two sets of two-bit pairs. A single ALM 1000 can be adapted this way because it includes two adder units.

A second set of two-bit pairs—A[i−2], A[i−3], B[i−2], and B[i−3]—is compared using look-up tables 1030 and 1040. As shown, the MSBs of both pairs of numbers (i.e., A[i−2] and B[i−2]) are input into look-up tables 1030 and 1040. The LSB of the pair of bits from number A (i.e., A[i−3]) is input into only look-up table 1030. Similarly, the LSB of the pair of bits from number B (i.e., B[i−3]) is input into only look-up table 1040.

The “left-side” and “right-side” of the compare operation and a C_{IN} 1020 from a previous compare operation (if any) are input into adder unit 1010. The output of adder unit 1010, C_{OUT} 1040, is input as C_{IN} 1080 into the next adder unit in the chain of adder units. The next adder unit, unit 1050, receives at its inputs C_{IN} 1080 and the “left-side” and “right-side” of the compare operation of a first set of two-bit pairs. The first set of two-bit pairs—A[i], A[i−1], B[i], and B[i−1]—is compared using look-up tables 1060 and 1070.

As illustrated, both look-up table 1060 and table 1070 have at least three inputs. Look-up table 1060 has as its inputs the MSBs of both pairs of numbers (i.e., A[i] and B[i]). Table 1060 also has as an input the LSB of the pair of bits from number A (i.e., A[i−1]). Table 1070 also has as its inputs the MSB of both pairs of numbers. In addition, table 1070 also has as an input the LSB of the pair of bits from number B (i.e., B[i−1]).

FIG. 10 also shows the logic that each look-up table performs on the inputs it receives. For example, the logic operations that table 1030 performs are “if A[i−2] is equal to B[i−2] then” the left-side output is “−A[i−3].” Otherwise, “if A[i−2]” is less than “B[i−2]” then the left-side output is 1. Otherwise, the left-side output is 0.

If adder unit 1050 is the last adder unit in the chain of adder units, the output 1090 of adder unit 1050 is determinative of the comparison between number A and number B. If output 1090 is 1, then number A is less than number B. If output 1090 is 0, then number A is equal to number B or greater than number B.

It is important to note that FIG. 10 shows only one possible implementation of comparing two pairs of two bits. That is, inputs into look-up tables are shown routed into those look-up tables in only one way. There are other possible implementations which are not represented or discussed here.

It is preferable that an additional adder unit beyond the adder units required to compare the bits of a number A and a number B is used when comparing numbers A and B. This adder unit receives as its input the carry out of the last adder unit (e.g., output 1090 of adder unit 1050) that was used in performing logic operations.

Therefore, for comparing two numbers each N-bits in length where adder unit compares a set of two-bit pairs, the number of adder units required to compare these two numbers is N divided by two (rounded up to the nearest whole number if two does not divide into N evenly) plus one. The plus one is for the additional adder unit that receives as its input the carry out of the last adder unit in the chain of adder units used in performing logic operations.

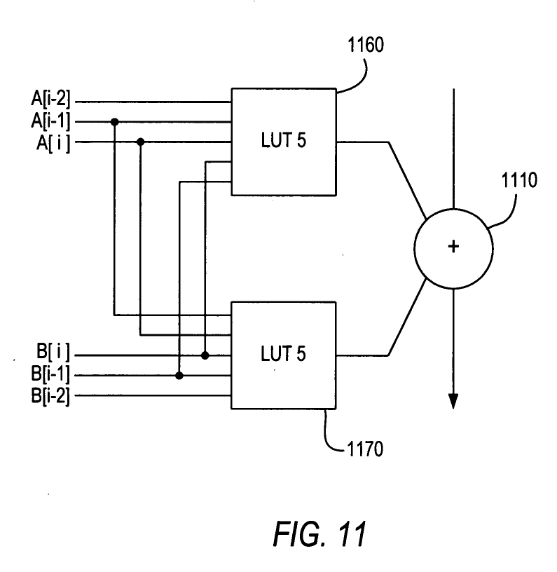

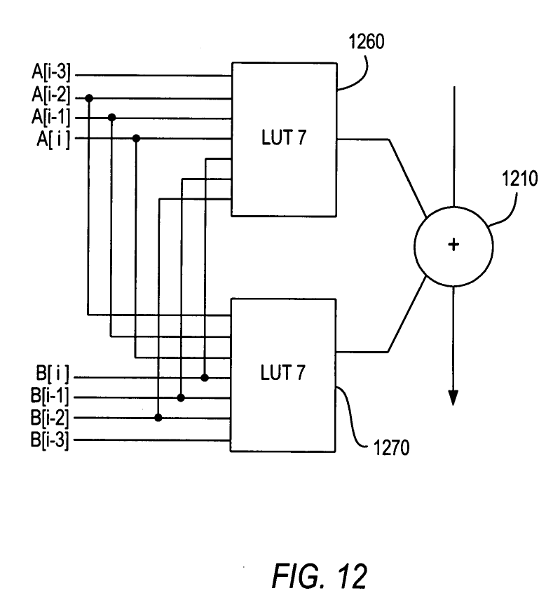

FIGS. 8A, 9, and 10 illustrate look-up tables that utilize three inputs. This is merely exemplary. Look-up tables can utilize more than three inputs in accordance with the present invention. For example, FIGS. 11 and 12 illustrate comparators that use look-up tables that have five and seven inputs, respectively.

Comparator 1100 of FIG. 11 uses two look-up tables, tables 1160 and 1170, that both have five inputs. Comparator 1200 of FIG. 12 uses two look-up tables, tables 1260 and 1270, that both have seven inputs. As shown, each look-up table has one output that is fed to an adder unit (e.g., adder unit 1110 of FIG. 11; adder unit 1210 of FIG. 12). The look-up tables receive a set of bits from a first number and a corresponding set of bits from a second number (in the same bit positions) less the least significant bit of the set of bits of the second number.

For example, look-up table 1160 receives a set of bits from a number A. Table 1160 receives bits in the i'th position, i−1 position, and i−2 position from number A. Additionally, table 1160 receives bits in the i'th position and i−1 position from a number B.

Tables 1160 and 1170 operate in a similar fashion to tables 960 and 970 except that the logic operations of tables 960 and 970 (i.e., logic 860 and 870) is surrounded by another “if . . . else . . . ” clause:

| if A[i] = B[i] then | |
|---|---|
| if A[i−1] = B[i−1] then | (−A[i−2],B[i−2]) |
| else if A[i−1] < B[i−1] then | (1,1) |
| else | (0,0) |
| else if A[i] < B[i] then | (1,1) |
| else | (0,0) |

Similarly, tables 1260 and 1270 operate in a similar fashion to logic tables 1160 and 1170 except that the logic performed by tables 1160 and 1170 are surrounded by another “if . . . else . . . ” clause:

| if A[i] = B[i] then | |
|---|---|
| if A[i−1] = B[i−1] then | |
| if A[i−2] = B[i−2] then | (−A[i−3],B[i−3]) |
| else if A[i−2] < B[i−2] then | (1, 1) |
| else | (0, 0) |
| else if A[i−1] < B[i−1] then | (1, 1) |
| else | (0, 0) |
| else if A[i] < B[i] then | (1, 1) |
| else | (0, 0) |

For tables that have additional bits as an input, another “if . . . else . . . ” clause surrounds the logic operations for each additional bit.

Generally, the look-up tables (logic units) used in accordance with the present invention use less inputs and logic elements than prior comparators. For example, the present invention can compare two eight-bit numbers using 5 Adaptive Look-Up Tables (“ALUTs”) in comparison to known comparators which require 6 ALUTs. To compare two sixteen-bit numbers, the present invention uses 9 ALUTs, known comparators use 14 ALUTs. To compare thirty-two-bit numbers, the present invention uses 17 ALUTs, known comparators use 32 ALUTs. To compare sixty-four-bit numbers, the present invention uses 33 ALUTs, known comparators use 66 ALUTs.

Comparators designed in accordance with the present invention are also faster than known comparators. The present invention can compare to eight-bit numbers in one nanosecond. Known comparators take 1.5 nanoseconds to compare two eight-bit numbers. The present invention compares two sixteen-bit numbers in 1.25 ns; known comparators, 4 ns. The present invention compares two thirty-two-bit numbers in 1.7 ns, known comparators 5.6 ns. The present invention compares two sixty-four-bit numbers in 2.4 ns, known comparators in 8.9 ns.

One skilled in the art will appreciate that the invention can be practiced by other than the described embodiments, which are presented for purposes of illustration and not of limitation, and the present invention is limited only by the claims which follows.

What is claimed is:

1. A logic element for use in a comparator, the logic element configured to:
receive a first logic value at a first input;
receive a second logic value at a second input;
receive a third logic value at a third input; and
output a logic value based on the first logic value, the second logic value, and the third logic value wherein the output is at least partially determinative in comparing a first number and a second number.

2. The logic element of claim 1 wherein the logic element is an adder unit.

3. The logic element of claim 1 wherein when the output is a logic value 1, the second number is greater than the first number.

4. The logic element of claim 1 wherein when the output is a logic value 0, the second number is less than the first number.

5. The logic element of claim 1 wherein when the output is a logic value 0, the second number is equal to the first number.

6. The logic element of claim 1 wherein the logic element is a first logic element in a chain of at least two logic elements.

7. The logic element of claim 6 wherein the output of the first logic element is the first input of a second logic element.

8. The logic element of claim 6 wherein the logic element is the first logic element in a chain of at least two logic elements and:
the second input of the first logic element is the output of a first logic unit for performing a logic operation on the least significant bit of a set of bits of a first number, the bit one bit more significant than the least significant bit of the set of bits of the first number, and the bit one bit more significant than the least significant bit of a set of bits of a second number;
the third input of the first logic element is the output of a second logic unit for performing a logic operation on the least significant bit of the set of bits of the second number, the bit one bit more significant than the least significant bit of the set of bits of the second number, and the bit one bit more significant than the least significant bit of the second set of bits of the first number.

9. The logic element of claim 8 wherein the output of the first logic unit is a logic value that is NOT the least significant bit of the set of bits of the first number if the bit one bit more significant than the least significant bit of the first set of numbers is equal to the bit one bit more significant than the least significant bit of the second set of numbers.

10. The logic element of claim 6 wherein the logic element is a second logic element in a chain of logic elements and:
the second input of the second logic element is the output of a first logic unit for performing a logic operation on the most significant bit of a set of bits of a first number, the most significant bit of a set of bits of a second number, and the second most significant bit of the set of bits of the first number;
the third input of the second logic element is the output of a second logic unit for performing a logic operation on the most significant bit of the set of bits of the first number, the most significant bit of the set of bits of the second number, and the second most significant bit of the set of bits of the second number.

11. The logic element of claim 10 wherein the output of the first logic unit is a logic value that is NOT the second most significant bit of the set of bits of the first number if the most significant bit of the first set of numbers is equal to the most significant bit of the second set of numbers.

12. Comparator circuitry for use in comparing at least two numbers, the comparator circuitry comprising a first logic unit, the first logic unit comprising:
a first input for receiving a first bit from a first number;
a second input for receiving a second bit from the first number;
a third input for receiving a first bit from a second number; and
a first output that outputs a logic value generated by the logic unit wherein:
the logic value is NOT the second bit from the first number when the first bit from the first number and the first bit from the second number are equal;
the logic value is 1 if the first bit from the first number is less than the first bit from the second number; and
the logic value is 0 if the first bit from the first number is greater than the first bit from the first number.

13. The comparator circuitry of claim 12 wherein the first output of the first logic unit is coupled to an input of an adder unit.

14. The comparator circuitry of claim 13 wherein the adder unit is implemented on an adaptive logic module.

15. The comparator circuitry of claim 12 wherein the first logic unit is an input table with at least three inputs.

16. The comparator circuitry of claim 12 wherein the first bit from the first number is the most significant bit of the first number.

17. The comparator circuitry of claim 12 wherein the first bit from the first number is a bit more significant than the second bit from the first number.

18. The comparator circuitry of claim 12 wherein the first bit from the first number and the first bit from the second number are from the same bit positions in respective first and second numbers.

19. The comparator circuitry of claim 12 wherein the first bit from the first number is one bit more significant than the second bit from the first number.

20. The comparator circuitry of claim 12 further comprising a second logic unit, the second logic unit comprising:
a fourth input for receiving the first bit from the second number;
a fifth input for receiving a second bit from the second number;
a sixth input for receiving the first bit from the first number; and
a second output that outputs a second logic value generated by the further logic unit wherein:
the second logic value is the second bit from the second number when the first bit from the first number and the first bit from the second number are equal;
the second logic value is 1 if the first bit from the first number is less than the first bit from the second number; and
the second logic value is 0 if the first bit from the first number is greater than the first bit from the first number.

21. The comparator circuitry of claim 20 wherein the second output of the second logic unit is coupled to an input of an adder unit.

22. The comparator circuitry of claim 21 wherein the first output of the first logic unit is coupled to an input of the adder unit.

23. The comparator circuitry of claim 22 wherein the adder unit has yet another input and receives a logic value from another adder unit at the another input.

24. The comparator circuitry of claim 23 wherein the adder unit has an output and produces a logic value at the output based on the first output of the first logic unit, the second output of the second logic unit, and the logic value received at the another input.

25. The comparator circuitry of claim 24 wherein if the output of the adder unit is a logic value 1, the first number is less than the second number.

26. The comparator circuitry of claim 24 wherein if the output of the adder unit is a logic value 0, the first number is equal to the second number.

27. The comparator circuitry of claim 24 wherein if the output of the adder unit is a logic value 0, the first number is greater than the second number.

28. The comparator circuitry of claim 24 wherein the adder unit is one adder unit in a chain of at least two adder units.

29. The comparator circuitry of claim 28 wherein the output of a first adder unit is coupled to the another input of a second adder unit.

30. A look-up table for use in a comparator, the look-up table configured to:
receive the bits of a first number;
receive the bits of a second number less the least significant bit of the second number; and
perform at least one logic operation using at least one bit of the bits received from the first number and at least one bit of the bits received from the second number;
produce an output based on the performed at least one logic operation.
